(19) United States
(12) Patent Application Publication
(10) Pub. No.: US 2025/0132366 A1
(43) Pub. Date: Apr. 24, 2025

(54) SOLID OXIDE FUEL CELL AND METHOD FOR MANUFACTURING THE SAME

(71) Applicant: KOREA INSTITUTE OF SCIENCE AND TECHNOLOGY, Seoul (KR)

(72) Inventors: Kyung Joong Yoon, Seoul (KR); Haewon Seo, Seoul (KR); Sungeun Yang, Seoul (KR); Deok-Hwang Kwon, Seoul (KR); Ho Il Ji, Seoul (KR); Hye Jung Chang, Seoul (KR); Hyoungchul Kim, Seoul (KR); Ji-Won Son, Seoul (KR); Jong Ho Lee, Seoul (KR)

(21) Appl. No.: 18/415,524

(22) Filed: Jan. 17, 2024

(30) Foreign Application Priority Data
Oct. 24, 2023 (KR) 10-2023-0142859

(51) Int. Cl. H01M 8/1213; H01M 4/88; H01M 4/90; H01M 8/12; H01M 8/1253

(52) U.S. Cl. CPC H01M 8/1213; H01M 4/8828; H01M 4/8885; H01M 4/9025; H01M 4/9058; H01M 8/1253; H01M 2008/1293

(57) ABSTRACT

The present invention provides a solid oxide fuel cell including a fuel electrode support including Ni-YSZ; a functional layer positioned on the fuel electrode support; an electrolyte layer positioned on the functional layer; an interlayer positioned on the electrolyte layer; and an air electrode layer positioned on the interlayer, wherein the functional layer includes gadolinium-doped ceria (GDC) nanoparticles dispersed.

### CROSS-REFERENCE TO RELATED APPLICATION

This application claims priority to and the benefit of Korean Patent Application No. 10-2023-0142859 filed in the Korean Intellectual Property Office on Oct. 24, 2023, the entire contents of which are incorporated herein by reference.

### BACKGROUND OF THE INVENTION

### (a) Field of the Invention

The present invention relates to a solid oxide fuel cell and a method for manufacturing the same, and specifically, to a solid oxide fuel cell with improved performance by including uniformly dispersed GDC nanoparticles and a method for manufacturing the same.

### (b) Description of the Related Art

A solid oxide fuel cell (SOFC) and a high-temperature water electrolysis cell (SOEC) are attracting attention as future energy technologies for power and fuel production because of their high energy conversion efficiency. The composite of metallic Ni and yttria-stabilized zirconia (YSZ), which is an oxygen ion conductive ceramic, are most widely used as fuel electrodes for SOFC and SOEC.

When ceria-based materials, which have electron-oxygen ion mixed conductivity and excellent ionic conductivity in a reducing atmosphere, are used for the fuel electrode, performance can be improved and carbon deposition can be suppressed. However, in the case of a fuel electrode-supported cell, which shows the highest performance in the SOFC and the SOEC, it is difficult to use ceria for the fuel electrode due to the nature of the manufacturing process.

Note that in the fuel electrode-supported cell, a fuel electrode serves as a support and a thin electrolyte membrane is deposited on the fuel electrode. In order to densify the electrolyte, the fuel electrode support and the electrolyte membrane are generally co-sintered at high temperatures of 1,400° C. or higher. At temperatures above 1300° C., a chemical reaction occurs between YSZ and ceria, creating a secondary phase with high electrical resistance.

Therefore, when ceria is used for the fuel electrode, ceria reacts with YSZ in the electrolyte after co-sintering, causing a rapid decrease in performance.

In the present invention, a cell is manufactured by introducing a small amount of gadolinia-doped ceria (GDC) nano-powder into an existing Ni-YSZ fuel electrode and co-sintering the same at a low temperature to densify the electrolyte. Because the sintering temperature is not high and a total amount of GDC is small, the increase in resistance due to the chemical reaction between GDC and YSZ is minimized. On the other hand, by uniformly dispersing GDC nano-powder, the effect of improving an electrode reaction rate is maximized, greatly improving SOFC and SOEC performance.

### SUMMARY OF THE INVENTION

An exemplary embodiment of the present invention is intended to provide a solid oxide fuel cell including uniformly dispersed GDC nanoparticles and a method for manufacturing the same.

A solid oxide fuel cell according to an exemplary embodiment of the present invention includes a fuel electrode support including Ni-YSZ; a fuel electrode functional layer positioned on the fuel electrode support; an electrolyte layer positioned on the functional layer; an interlayer positioned on the electrolyte layer; and an air electrode layer positioned on the interlayer.

The functional layer may include gadolinium-doped ceria (GDC) nanoparticles.

The gadolinium-doped ceria (GDC) nanoparticles may be included within a range of 0.1 wt % to 10.0 wt % based on a total mass of the functional layer.

An average particle size (D50) of the gadolinium-doped ceria (GDC) nanoparticles may range from 10 nm to 200 nm.

A thickness of the functional layer may range from 3 μm to 30 μm, and the functional layer may include a metal catalyst and an oxide.

The oxide may include one or more selected from zirconium oxide, cerium oxide, lanthanum gallate, barium cerate, barium zirconate, or barium zirconate-cerate.

The metal catalyst may include one or more selected from nickel, ruthenium, palladium, rhodium, or platinum.

The electrolyte layer may include one or more selected from YSZ, BZY, BCY, or BCZY, and a thickness of the electrolyte layer may range from 1 μm to 10 μm.

The interlayer may include one or more selected from Ni-BZY, Ni-BCY, Ni-BCZY, Ni-BZCYYb, or GDC, and a thickness of the interlayer may range from 1 μm to 10 μm.

A method for manufacturing a solid oxide fuel cell according to another exemplary embodiment of the present invention may include preparing a fuel electrode support including Ni-YSZ; sequentially applying a slurry including a functional layer material and gadolinium-doped ceria (GDC) nanoparticles and an electrolyte material slurry on the fuel electrode support and then performing primary sintering to form a functional layer and an electrolyte layer; applying an interlayer material on the electrolyte layer and then performing secondary sintering to form an interlayer; and applying an air electrode layer material on the interlayer and then performing tertiary sintering to form an air electrode layer.

In the step of sequentially applying a slurry including a functional layer material and gadolinium-doped ceria (GDC) nanoparticles and an electrolyte material slurry on the fuel electrode support and then performing primary sintering to form a functional layer and an electrolyte layer, the primary sintering may be performed at temperatures ranging from 1300° C. to 1350° C.

In the step of sequentially applying a slurry including a functional layer material and gadolinium-doped ceria (GDC) particles and an electrolyte material slurry on the fuel electrode support and then performing primary sintering to form a functional layer and an electrolyte layer, an average size of the gadolinium-doped ceria (GDC) nanoparticles in the slurry including the functional layer material and the gadolinium-doped ceria (GDC) nanoparticles may be 10 nm to 200 nm.

In the step of sequentially applying a slurry including a functional layer material and gadolinium-doped ceria (GDC) particles and an electrolyte material slurry on the fuel electrode support and then performing primary sintering to form a functional layer and an electrolyte layer, a weight percentage of the gadolinium-doped ceria (GDC) nanoparticles may be 0.1 wt % to 10.0 wt % based on a total weight of the slurry including the functional layer material and the gadolinium-doped ceria (GDC) nanoparticles.

In the step of sequentially applying a slurry including a functional layer material and gadolinium-doped ceria (GDC) particles and an electrolyte material slurry on the fuel electrode support and then performing primary sintering to form a functional layer and an electrolyte layer, a thickness of the formed functional layer may range from 1 μm to 35 μm, specifically 3 μm to 30 μm, and more specifically 3 μm to 12 μm.

In the step of sequentially applying a slurry including a functional layer material and gadolinium-doped ceria (GDC) particles and an electrolyte material slurry on the fuel electrode support and then performing primary sintering to form a functional layer and an electrolyte layer, a thickness of the formed electrolyte layer may range 1 μm to 10 μm, specifically 2 μm to 5 μm, and more specifically 2.5 μm to 3.5 μm.

In the step of sequentially applying a slurry including a functional layer material and gadolinium-doped ceria (GDC) particles and an electrolyte material slurry on the fuel electrode support and then performing primary sintering to form a functional layer and an electrolyte layer, the slurry may be applied by a slurry spin coating method.

In the step of sequentially applying a slurry including a functional layer material and gadolinium-doped ceria (GDC) particles and an electrolyte material slurry on the fuel electrode support and then performing primary sintering to form a functional layer and an electrolyte layer, the functional layer material may include a metal catalyst and an oxide, and the oxide may include one or more selected from zirconium oxide, cerium oxide, lanthanum gallate, barium cerate, barium zirconate, or barium zirconate-cerate.

The metal catalyst may include one or more selected from nickel, ruthenium, palladium, rhodium, or platinum.

In the step of sequentially applying a slurry including a functional layer material and gadolinium-doped ceria (GDC) particles and an electrolyte material slurry on the fuel electrode support and then performing primary sintering to form a functional layer and an electrolyte layer, the electrolyte material may include one or more selected from YSZ, BZY, BCY and BCZY.

In the step of applying an interlayer material on the electrolyte layer and then performing secondary sintering to form an interlayer, the secondary sintering may be performed at a temperature ranging from 1200° C. to 1300° C. A thickness of the formed interlayer may range from 1 μm to 10 μm, specifically 2 μm to 5 μm, and more specifically 2.5 μm to 3.5 μm.

In the step of applying an interlayer material on the electrolyte layer and then performing secondary sintering to form an interlayer, the interlayer material may include one or more selected from Ni-BZY, Ni-BCY, Ni-BCZY, and GDC.

In the step of applying an air electrode layer material on the interlayer and then performing tertiary sintering to form an air electrode layer, the tertiary sintering may be performed at a temperature ranging from 900° C. to 1000° C.

The solid oxide fuel cell according to an exemplary embodiment of the present invention has the effect of improving electrochemical performance by minimizing an increase in resistance and improving an electrode reaction rate.

### BRIEF DESCRIPTION OF THE DRAWINGS

FIG. 1 shows a cross-sectional view of a solid oxide fuel cell according to an exemplary embodiment of the present invention.

FIG. 2 shows a cross-sectional SEM image of a unit cell prepared according to Example 2.

FIG. 3 shows an EDS analysis result of a cross section of a unit cell prepared according to Example 1.

FIG. 4 is a current density-voltage-output density graph obtained by measuring an open circuit voltage and performance of unit cells prepared in Example 1 of the present invention and Comparative Example 1.

FIG. 5 shows an evaluation result of CO2 electrolysis performance of the unit cells prepared in Example 1 of the present invention and Comparative Example 1.

### DETAILED DESCRIPTION OF THE EMBODIMENTS

The terms such as first, second and third are used for describing, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present invention.

The technical terms used herein are set forth only to mention specific exemplary embodiments and are not intended to limit the present invention. Singular forms used herein are intended to include the plural forms as long as phrases do not clearly indicate an opposite meaning. In the present specification, the term “including” is intended to embody specific characteristics, regions, integers, steps, operations, elements and/or components, but is not intended to exclude presence or addition of other characteristics, regions, integers, steps, operations, elements, and/or components.

When a part is referred to as being “above” or “on” another part, it may be directly above or on the other part or an intervening part may also be present. In contrast, when a part is referred to as being “directly above” another part, there is no intervening part present.

Unless otherwise defined, all terms including technical and scientific terms used herein have the same meanings as the meanings generally understood by one skilled in the art to which the present invention pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

In addition, unless otherwise specified, % means wt % (% by weight), and 1 ppm is 0.0001 wt %.

In the present specification, the term “combination(s) thereof” included in the expression of the Markush format means one or more mixtures or combinations selected from the group consisting of the constituent elements described in the expression of the Markush format, and means including one or more selected from the group consisting of the constituent elements.

Hereinafter, an exemplary embodiment of the present invention will be described in detail so that one skilled in the art to which the present invention pertains can easily implement the present invention.

As those skilled in the art would realize, the described embodiments may be modified in various different ways, all without departing from the spirit or scope of the present invention.

### 1. Solid Oxide Fuel Cell

An exemplary embodiment of the present invention provides a solid oxide fuel cell.

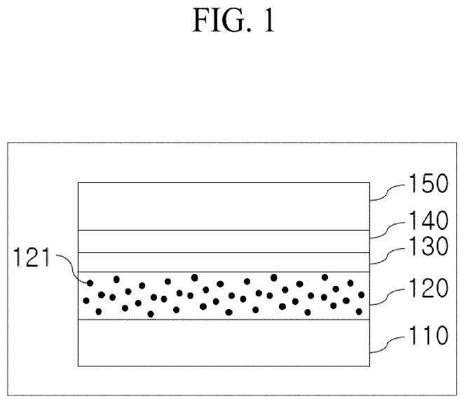

FIG. 1 shows a cross-sectional view of a solid oxide fuel cell according to an exemplary embodiment of the present invention.

Referring to FIG. 1, a solid oxide fuel cell according to an exemplary embodiment of the present invention may include an fuel electrode support 110 including Ni-YSZ, a functional layer 120 positioned on the fuel electrode support, an electrolyte layer 130 positioned on the functional layer, an interlayer 140 positioned on the electrolyte layer, and an air electrode layer 150 positioned on the interlayer, and the functional layer 120 may include gadolinium-doped ceria (GDC) nanoparticles 121.

In the fuel cell, the fuel electrode support 110 including Ni-YSZ may have a single-layer structure or a multi-layer structure.

The functional layer 120 may include a metal catalyst and an oxide. The oxide of the functional layer 120 may include one or more selected from zirconium oxide, cerium oxide, lanthanum gallate, barium cerate, barium zirconate, or barium zirconate-cerate, and more specifically, may include one or more selected from samaria-doped ceria (SDC), gadolinia-doped ceria (GDC), yttria-stabilized zirconia (YSZ), scandia-stabilized zirconia (ScSZ), strontium manganese-doped lanthanum gallate (LSGM), yttria-doped barium zirconate (BZY), yttria-doped barium cerate (BCY), or yttria-doped barium zirconate-cerate (BCZY).

The metal catalyst of the functional layer 120 may include one or more selected from nickel, ruthenium, palladium, rhodium, or platinum.

In the present invention, the functional layer 120 may include, more specifically, Ni-YSZ.

Note that the functional layer 120 may include gadolinium-doped ceria (GDC) nanoparticles 121.

The gadolinium-doped ceria (GDC) nanoparticles 121 may be included within a range of 0.1 wt % to 10.0 wt %, and specifically 0.5 wt % to 2.0 wt % based on a total mass of the functional layer 120.

The GDC nanoparticles 121 may be uniformly dispersed in the functional layer 120, and specifically, may be uniformly dispersed in the functional layer 120 and on a surface thereof.

An average particle size (D50) of the GDC nanoparticles 121 may be 250 nm or less, specifically 200 nm or less, and more specifically 10 nm to 200 nm.

When the GDC nanoparticles 121 are within the weight percentage range and the average particle size range described above, an increase in resistance due to a chemical reaction between the GDC and the oxide included in the functional layer can be minimized, and an effect of improving an electrode reaction rate can be maximized.

A thickness of the functional layer 120 may be 3 μm to 12 μm. When the thickness of the functional layer 120 is within the above range, the fuel cell can be constructed without structural defects, and the desired effect of the functional layer can be achieved.

The electrolyte layer 130 may include one or more selected from yttria-stabilized zirconia (YSZ), yttrium-doped barium zirconate (BZY), yttrium-doped barium cerate (BCY), or yttrium-doped barium zirconate-cerate (BCZY), and may specifically include yttria-stabilized zirconia (YSZ).

A thickness of the electrolyte layer 130 may be 2.5 μm to 3.5 μm.

The interlayer 140 may include one or more selected from nickel-barium zirconium yttrium oxide (Ni-BZY), nickel-barium cerium yttrium oxide (Ni-BCY), nickel-barium cerium zirconium yttrium oxide (Ni-BCZY), nickel-barium zirconium cerium yttrium ytterbium oxide (Ni-BZCYYb) or gadolinium-doped ceria (GDC), and may specifically include gadolinium-doped ceria (GDC).

A thickness of the interlayer 140 may range from 1 μm to 10 μm, specifically 2 μm to 5 μm, and more specifically 2.5 μm to 3.5 μm.

The air electrode 140 may be one or more selected from the group consisting of platinum (Pt), silver (Ag), lanthanum oxide-based perovskites such as lanthanum-strontium manganese oxide (LSM), lanthanum-strontium iron oxide (LSF), lanthanum-strontium cobalt iron oxide (LSCF) and lanthanum-strontium cobalt oxide (LSC), samarium-strontium cobalt oxide (SSC) single phase, or a mixture of hydrogen ion conductive oxides such as BZY, BCY and BZCY and the above materials.

However, the present invention is not limited thereto.

### 2. Method for Manufacturing Solid Oxide Fuel Cell

A method for manufacturing a solid oxide fuel cell according to another exemplary embodiment of the present invention may include preparing a fuel electrode support including Ni-YSZ; sequentially applying a slurry including a functional layer material and gadolinium-doped ceria (GDC) nanoparticles and an electrolyte material slurry on the fuel electrode support and then performing primary sintering to form a functional layer and an electrolyte layer; applying an interlayer material on the electrolyte layer and then performing secondary sintering to form an interlayer; and applying an air electrode layer material on the interlayer and then performing tertiary sintering to form an air electrode layer.

First, the step of preparing a fuel electrode support including Ni-YSZ is performed. Specifically, a NiO—(Y₂O₃)_{0.08}(ZrO₂)_{0.92}(YSZ) green sheet made by a tape casting may be sintered at a temperature of about 1000° C. to prepare a fuel electrode support layer with a thickness of about 300 μm.

Next, the step of sequentially applying a slurry including a functional layer material and gadolinium-doped ceria (GDC) nanoparticles and an electrolyte material slurry on the fuel electrode support and then performing primary sintering to form a functional layer and an electrolyte layer is performed.

Specifically, a step of applying a slurry including a functional layer material and gadolinium-doped ceria (GDC) nanoparticles on the fuel electrode support may be performed, and then an electrolyte material slurry may be applied.

The slurry including the functional layer material and gadolinium-doped ceria (GDC) nanoparticles may be prepared by mixing and milling the functional layer material and GDC particles with α-terpineol and ethylcellulose using planetary ball milling. In this case, the GDC may be included in an amount of 0.1 wt % to 10.0 wt %, specifically 0.1 wt % to 5.0 wt %, and more specifically, 0.5 wt % to 2.0 wt % based on a total weight of the slurry including the functional layer material and GDC nanoparticles. By adjusting the weight percentage of the GDC in the slurry within the above range, a fuel cell with improved electrode reaction rate can be manufactured.

Note that the functional layer material may include a metal catalyst and an oxide, the oxide may include one or more selected from zirconium oxide, cerium oxide, lanthanum gallate, barium cerate, barium zirconate, or barium zirconate-cerate, and the metal catalyst may include one or more selected from nickel, ruthenium, palladium, rhodium, or platinum.

In addition, an average particle size (D50) of the GDC nanoparticles in the slurry including the finally obtained functional layer material and GDC nanoparticles may be 250 nm or less, specifically 200 nm or less, and more specifically 10 nm to 200 nm. Adjusting the size of the GDC particles in the slurry within the above range is advantageous for stably forming a functional layer in a primary sintering process described below.

A concentration of the slurry including the functional layer material and GDC nanoparticles may be 50 wt % to 60 wt % based on an amount of solid loading. That is, the solid content (functional layer material and GDC nanoparticles) may be included within a range of 50 wt % to 60 wt % based on a total weight of the slurry.

The slurry including the functional layer material and GDC nanoparticles may be applied on the fuel electrode support, and then the electrolyte material slurry may be applied thereon. The electrolyte slurry may include one or more selected from yttria-stabilized zirconia (YSZ), yttrium-doped barium zirconate (BZY), yttrium-doped barium cerate (BCY), or yttrium-doped barium zirconate-cerate (BCZY), and a solvent may be α-terpineol.

A concentration of the electrolyte slurry may be 20 wt % to 30 wt % based on an amount of solid loading.

In the present invention, the slurry including the functional layer material and GDC nanoparticles and the electrolyte material slurry can be applied on the fuel electrode support by slurry spin coating.

After the slurry including the functional layer material and GDC nanoparticles and the electrolyte material slurry are sequentially applied on the fuel electrode support, a primary sintering may be performed on the resulting fuel electrode support, a slurry layer including the functional layer material and GDC nanoparticles, and an electrolyte material slurry layer.

In this case, the primary sintering may be performed at temperatures ranging from 1300° C. to 1350° C., and specifically, at a temperature of about 1320° C. to form a functional layer and an electrolyte layer. A thickness of the functional layer formed at this time may range from 1 μm to 35 μm, specifically 3 μm to 30 μm, and more specifically 3 μm to 12 μm. In addition, a thickness of the formed electrolyte layer may range from 1 μm to 10 μm, specifically 2 μm to 5 μm, and more specifically 2.5 μm to 3.5 μm.

Maintaining the primary sintering temperature within the above range is advantageous for preventing generation of a secondary phase with high resistance due to a chemical reaction between the functional layer material and the GDC nanoparticles.

After the primary sintering is completed, cooling to room temperature may be performed.

Next, the step of applying an interlayer material on the electrolyte layer and then performing secondary sintering to form an interlayer is performed.

The interlayer material may include one or more selected from Ni-BZY, Ni-BCY, Ni-BCZY, Ni-BZCYYb, or GDC, and the interlayer material may be applied on the electrolyte layer by a screen printing method.

The secondary sintering may be performed at temperatures of 1200° C. or higher, specifically at temperatures ranging from 1200° C. to 1300° C., and more specifically, at temperatures ranging from 1230° C. to 1270° C. to form an interlayer.

After the secondary sintering is completed, cooling to room temperature may be performed.

Next, an air electrode layer material may be applied on the formed interlayer and tertiary sintering may be performed to form an air electrode layer.

Specifically, the air electrode layer material may be applied on the interlayer by a screen printing method.

The tertiary sintering may be performed at temperatures ranging from 900° C. to 1000° C., and specifically at temperatures ranging from 930° C. to 970° C.

Below, preferred Examples of the present invention and Comparative Examples will be described. However, the following Examples are only preferred examples of the present invention, and the present invention is not limited to the following Examples.

### Example 1

First, a NiO—(Y₂O₃)_{0.08}(ZrO₂)_{0.92}(YSZ) green sheet made by a tape casting was sintered at a temperature of 1050° C. to prepare a fuel electrode support layer with a thickness of about 300 μm. A pure NiO-YSZ slurry and a NiO-YSZ slurry including 1.0 wt % of nano-sized GDC powder with a particle size of 10 nm to 200 nm were prepared using planetary ball milling, and the slurry concentration was 50 wt %. The pure NiO-YSZ and GDC-doped NiO-YSZ fuel electrode functional layers were applied to the surface of the NiO-YSZ fuel electrode support layer by slurry spin coating. An YSZ electrolyte was applied in the same way and then sintered together with the fuel electrode at about 1320° C. for 5 hours. At this time, the sintering was performed under atmospheric gas and normal pressure conditions. At this time, a 12 μm thick functional layer and a 3 μm thick electrolyte layer were formed.

Next, a GDC interlayer was formed on the electrolyte layer by screen printing, and then sintered at about 1250° C. for 2 hours to form a 3 μm thick interlayer.

Next, an LSC air electrode layer was formed on the interlayer by screen printing, and then sintered at about 950° C. for 2 hours to form a 20 μm thick air electrode layer.

Finally, a unit cell of a solid oxide fuel cell including a functional layer containing GDC nanoparticles was prepared.

### Comparative Example 1

A unit cell of a solid oxide fuel cell including a functional layer not containing GDC nanoparticles was prepared in the same manner as in the Example, except that the functional layer was formed using a NiO-YSZ slurry not including GDC powder.

### (SEM Analysis)

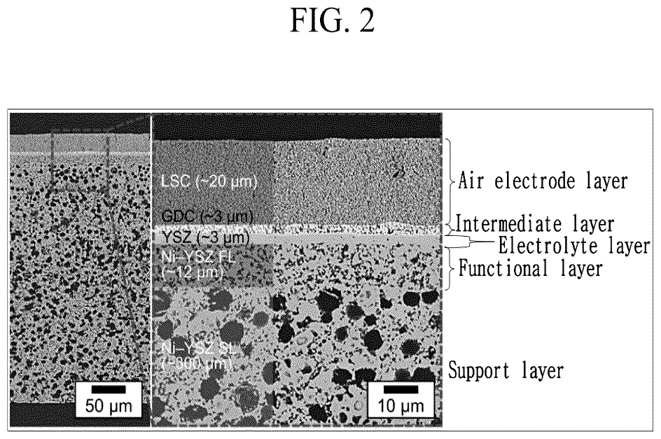

A cross-sectional SEM image of the unit cell prepared according to Example 1 is shown in FIG. 2.

Referring to FIG. 2, it can be confirmed that the unit cell prepared according to Example 1 was formed with a support layer, a functional layer, an electrolyte layer, an interlayer, and an air electrode layer stacked sequentially.

### (EDS Analysis)

Energy dispersive spectroscopy (EDS) analysis was performed on the cross section of the unit cell prepared according to Example 1 using a field emission scanning electron microscope (FE-SEM).

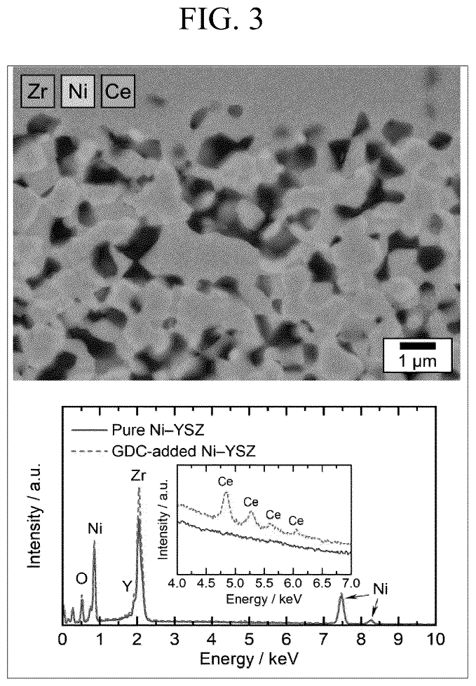

FIG. 3 shows an EDS analysis result of a cross section of the unit cell prepared according to Example 1. Referring to FIG. 3, since the size and amount of GDC particles are smaller compared to the surrounding particles (Ni and YSZ), the GDC particles are hardly observed in EDS mapping, but Ce component is detected on the EDS spectrum, confirming the presence of GDC.

### (CO₂ Electrolysis Performance Evaluation)

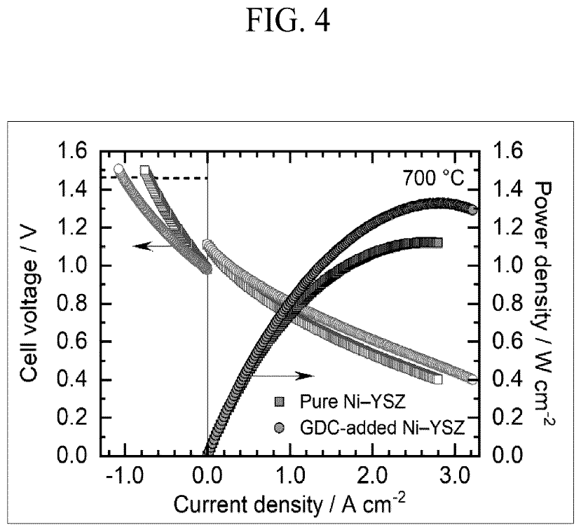

FIG. 4 is a current density-voltage-output density graph obtained by measuring an open circuit voltage and performance of unit cells prepared in Example 1 of the present invention and Comparative Example 1.

Referring to FIG. 4, it can be confirmed that when the Ni-YSZ fuel electrode added with nano-sized GDC of Example 1 was used, the maximum power density was improved from 1.12 to 1.33 W·cm⁻² compared to the cell using the Ni-YSZ fuel electrode of Comparative Example 1.

Note that referring to FIG. 4, it can be confirmed that the electrolytic current density at a thermoneutral voltage (VTN; ˜1.46 V @700° C.) was improved to 0.72 to 1.03 A·cm.

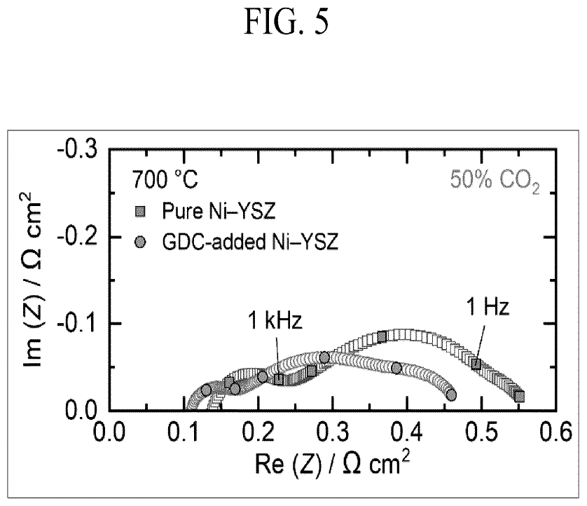

FIG. 5 shows an evaluation result of CO₂ electrolysis performance of the unit cells prepared in Example 1 of the present invention and Comparative Example 1.

Referring to FIG. 5, it can be confirmed through the electrochemical impedance spectroscopy that by adding a small amount of nano-sized GDC, the total resistance was reduced by about 16%, i.e., from 0.55 Ω·cm² to 0.46 Ω·cm². This is believed to be due to decreases in ohmic resistance and polarization resistance.

While the present invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

Therefore, it should be noted that the practical scope of the present invention is defined by the appended claims and equivalents thereof.

### DESCRIPTION OF SYMBOLS

110: fuel electrode support
120: functional layer
121: nanoparticle
130: electrolyte layer
140: interlayer
150: air electrode layer

What is claimed is:

1. A solid oxide fuel cell comprising:
a fuel electrode support comprising Ni-YSZ;
a fuel electrode functional layer positioned on the fuel electrode support;
an electrolyte layer positioned on the functional layer;
an interlayer positioned on the electrolyte layer; and
an air electrode layer positioned on the interlayer,
wherein the functional layer comprises gadolinium-doped ceria (GDC) nanoparticles.

2. The solid oxide fuel cell of claim 1, wherein
the gadolinium-doped ceria (GDC) nanoparticles are included within a range of 0.1 wt % to 10.0 wt % based on a total mass of the functional layer.

3. The solid oxide fuel cell of claim 1, wherein
an average particle size (D50) of the gadolinium-doped ceria (GDC) nanoparticles ranges from 10 nm to 200 nm.

4. The solid oxide fuel cell of claim 1, wherein
a thickness of the functional layer ranges from 3 μm to 30 μm.

5. The solid oxide fuel cell of claim 1, wherein
the functional layer comprises a metal catalyst and an oxide, and
wherein the oxide comprises one or more selected from zirconium oxide, cerium oxide, lanthanum gallate, barium cerate, barium zirconate or barium zirconate-cerate.

6. The solid oxide fuel cell of claim 5, wherein
the metal catalyst comprises one or more selected from nickel, ruthenium, palladium, rhodium, or platinum.

7. The solid oxide fuel cell of claim 1, wherein
the electrolyte layer comprises one or more selected from YSZ, BZY, BCY or BCZY.

8. A method for manufacturing a solid oxide fuel cell, the method comprising:
preparing a fuel electrode support including Ni-YSZ;
sequentially applying a slurry comprising a functional layer material and gadolinium-doped ceria (GDC) nanoparticles and an electrolyte material slurry on the fuel electrode support and then performing primary sintering to form a functional layer and an electrolyte layer;
applying an interlayer material on the electrolyte layer and then performing secondary sintering to form an interlayer; and
applying an air electrode layer material on the interlayer and then performing tertiary sintering to form an air electrode layer.

9. The method of claim 8, wherein
in the step of sequentially applying a slurry comprising a functional layer material and gadolinium-doped ceria (GDC) nanoparticles and an electrolyte material slurry on the fuel electrode support and then performing primary sintering to form a functional layer and an electrolyte layer,
the primary sintering is performed at a temperature ranging from 1300° C. to 1350° C.

10. The method of claim 8, wherein
in the step of sequentially applying a slurry comprising a functional layer material and gadolinium-doped ceria (GDC) particles and an electrolyte material slurry on the fuel electrode support and then performing primary sintering to form a functional layer and an electrolyte layer,
an average size of the gadolinium-doped ceria (GDC) nanoparticles in the slurry comprising the functional layer material and the gadolinium-doped ceria (GDC) nanoparticles is 10 nm to 200 nm.

11. The method of claim 8, wherein
in the step of sequentially applying a slurry comprising a functional layer material and gadolinium-doped ceria (GDC) particles and an electrolyte material slurry on the fuel electrode support and then performing primary sintering to form a functional layer and an electrolyte layer,
a weight percentage of the gadolinium-doped ceria (GDC) nanoparticles is 0.1 wt % to 10.0 wt % based on a total weight of the slurry comprising the functional layer material and the gadolinium-doped ceria (GDC) nanoparticles.

12. The method of claim 8, wherein
in the step of sequentially applying a slurry comprising a functional layer material and gadolinium-doped ceria (GDC) particles and an electrolyte material slurry on the fuel electrode support and then performing primary sintering to form a functional layer and an electrolyte layer,
a thickness of the formed functional layer ranges from 3 μm to 30 μm.

13. The method of claim 8, wherein
in the step of sequentially applying a slurry comprising a functional layer material and gadolinium-doped ceria (GDC) particles and an electrolyte material slurry on the fuel electrode support and then performing primary sintering to form a functional layer and an electrolyte layer,
a thickness of the formed electrolyte layer ranges from 1 μm to 10 μm.

14. The method of claim 8, wherein
in the step of sequentially applying a slurry comprising a functional layer material and gadolinium-doped ceria (GDC) particles and an electrolyte material slurry on the fuel electrode support and then performing primary sintering to form a functional layer and an electrolyte layer,
the slurry is applied by a slurry spin coating method.

15. The method of claim 8, wherein
in the step of sequentially applying a slurry comprising a functional layer material and gadolinium-doped ceria (GDC) particles and an electrolyte material slurry on the fuel electrode support and then performing primary sintering to form a functional layer and an electrolyte layer,
the functional layer material comprises a metal catalyst and an oxide, and
wherein the oxide comprises one or more selected from zirconium oxide, cerium oxide, lanthanum gallate, barium cerate, barium zirconate or barium zirconate-cerate.

16. The method of claim 15, wherein
the metal catalyst comprises one or more selected from nickel, ruthenium, palladium, rhodium, or platinum.

17. The method of claim 8, wherein
in the step of sequentially applying a slurry comprising a functional layer material and gadolinium-doped ceria (GDC) particles and an electrolyte material slurry on the fuel electrode support and then performing primary sintering to form a functional layer and an electrolyte layer,
the electrolyte material comprises one or more selected from YSZ, BZY, BCY and BCZY.

18. The method of claim 8, wherein
in the step of applying an interlayer material on the electrolyte layer and then performing secondary sintering to form an interlayer,
the secondary sintering is performed at a temperature ranging from 1200° C. to 1300° C.

19. The method of claim 8, wherein
in the step of applying an interlayer material on the electrolyte layer and then performing secondary sintering to form an interlayer,
the interlayer material comprises one or more selected from Ni-BZY, Ni-BCY, Ni-BCZY and GDC.
